(19) United States
(12) Patent Application Publication
(10) Pub. No.: US 2007/0234971 A1
(43) Pub. Date: Oct. 11, 2007

(54) Housetraining shirt for pets

(76) Inventor: Donna Pegago, Coxs Creek, KY (US)

Correspondence Address: CHARLESS LEE THOMASON, P.O. Box 745, 106 N. 4th St., BARDSTOWN, KY, 40004, US

(21) Appl. No.: 11/786,320

(22) Filed: Apr. 11, 2007

Related U.S. Application Data
(60) Provisional application No. 60/790,944, filed on Apr. 11, 2006.

(51) Int. Cl. A01K 13/00; A01K 37/00

(52) U.S. Cl. 119/850; 119/712

(57) ABSTRACT

Useful in the art of housetraining a dog not to urinate indoors, the disclosed invention is a housetraining shirt that partially covers the dog, which prevent wetness on indoor surfaces, and which provides the dog with a reason to prefer to be let out to urinate and to indicate a desire to be let out for that purpose.

This application claims priority to U.S. Provisional Patent Application 60/790,944, filed Apr. 11, 2006.

### BACKGROUND OF INVENTION

Dog training relies on instilling positive and negative associations, such as the positive reinforcement using food, or negative reinforcement from creating situations that the pet wants to avoid. Training aids create the desired response from the pet, from which the dog learns to act consistent with the desired, trained response, and to do so after the training aid no longer is used. Training aids to housetrain a dog against urinating indoors include the teaching lease and crate that Hodgson described in U.S. Pat. No. 5,551,380.

### SUMMARY OF THE INVENTION

In summary, the invention is a garment that fits on a house pet, typically a dog. The fitted features serve to keep the housetraining shirt from being pulled off by the pet, but allow the pet full movement. The shirt-like garment is a flexible or stretchable material, that covers the area around the urination opening on male and female dogs, and may too cover the hind quarters on female dogs.

When worn inside the house, by a dog that is being trained to go outside to urinate, the housetraining shirt has a pad covering the urination opening, which pad area will become wetted if the dog urinates while wearing it. This wetness is a sort of discomfort or negative association that trains the dog to avoid it. The housetraining shirt trains the dog to prefer to not urinate indoors when wearing the aid, to prefer to have the garment removed and to be let outside the house to urinate.

Although someone skilled with dog training can teach a dog to indicate it wants to be let outside to urinate, pet owners in general do not know how to teach that response. What is needed is a simple garment that provides a training aid that enables a dog owner to teach their dog not to urinate indoors, and to teach the dog to indicate wanting to be let outdoors to urinate.

### DESCRIPTION OF THE DRAWINGS

FIGS. 1 and 2 depict the invention as worn by the dog.

### DESCRIPTION OF THE INVENTION

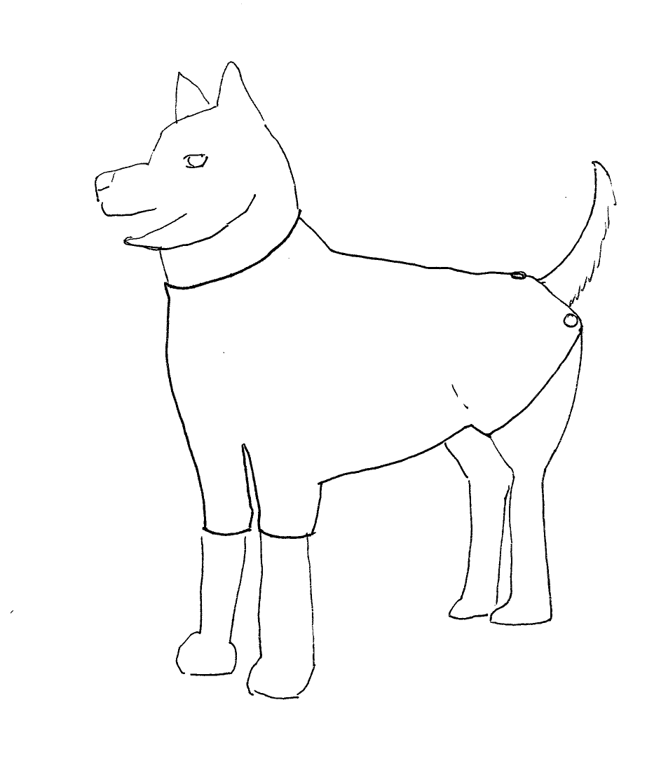

One preferred embodiment of this housetraining aid is similar to a shirt, having an opening for the dog's head, or collar that fits around the neck, and below that opening or collar, the shirt has two sleeves that are fitted for the dog's front legs. Also, the shirt covers the body of the pet, at least to the extent that it will prevent it from being pulled off or rubbed off by the dog. The shirt is open, at the hindquarters of the pet, when slipped onto the pet, but the housetraining shirt has a flap to be closed over the rear. The shirt has a flap that goes under the rear of the dog's body and through the rear legs, then is pulled up to meet with the portion of the shirt that extends from the neck hole and down the backbone of the dog. The flap typically has two snaps or closures, which clasp on either side of the tail of the dog. With these snaps or clasps closed, the tail can extend out. This preferred embodiment is more readily understood by reference to the attached FIGS. 1 and 2. The typical embodiment will have a shirt body with a neck band, foreleg sleeves, underbody flap with a training pad and closures to the shirt body which form a tail opening. The parts of the housetraining shirt, more in detail for a preferred embodiment, are a back portion, a neck collar, foreleg sleeves, and a belly portion. The training pad preferably is an absorbent piece of material, which may be joined to the shirt, or integrally woven to it. The pad also may simply define an area of the shirt material, which covers the urination opening of the dog when the shirt is on the animal. In the preferred embodiment, the pad is part of the belly portion, and the back portion extends between a fore part, which fits along the backbone and neck of the animal, and a rear part, which extends back to the tail of the animal; and, the belly portion extends between a foreleg part, which joins to the foreleg sleeves, and a hindleg part, which runs across the animal's belly up to its hind area, where closures on it clasp to closures on the rear part of the back portion of the housetraining shirt. Typically, there are two closures on the back portion and the belly portion, and the dog's tail will pass between those.

In use, the shirt pulls over the dog's head, the front legs go into the sleeves, and the shirt is pulled over the dog's body toward the hindquarters. To close the open bottom of the shirt, the flap is pulled across the belly, then between the hind legs, up around the tail, and typically with closures that snap on either side of the tail to the body of the housetraining shirt. So constructed and fitted, the garment covers the dog's privates, preferably with the training pad against the urination opening. The shirt is intended to be worn indoors for training. If the dog urinates indoors, the shirt catches that. This prevents damage to home furnishings. Also, the wet area makes the dog uncomfortable. The dog is scolded when the wet shirt is removed, and the dog may be put in his crate as punishment. Later, the dog is let outside, and when coming back in the house, a fresh shirt is slipped on the dog. When the dog indicates it wants to be let outside the house to relieve itself, the housetraining shirt is slipped off, and when the dog comes back indoors, the shirt is slipped and snapped back on them. By use of the training aid, the dog learns the desired response, and the shirt no longer needs to be used.

In addition to being an aid for house training, the shirt is useful on males who wish to “mark” their area, as well as for females during heat. The absorbency of the shirt, especially on the flap area of the shirt, prevents damage and odors on household furnishings. The fitted features of the shirt, as shown on the preferred embodiment, can be altered depending on characteristics of the house pet. However, the primary aspect of the fitted features is to keep the garment from being pulled or rubbed off by the pet. Thus, features of the invention are a combination of elements that make the garment hard for the dog to remove, that contact parts of the dog's body for comfort and for training, and that make the invention easy and inexpensive to use effectively for training.

I claim:

1. A housetraining aid that partially covers the body of a dog having a tail, comprising:
A back portion, a neck collar, foreleg sleeves, and a belly portion; said back portion extending between a fore part and a rear part; said belly portion extending between a foreleg part and a hindleg part; said neck collar joined between said fore part, said foreleg sleeves, and said foreleg part; said belly portion and said back portion having releasable closures on said rear part of said back portion and said hindleg part of said belly portion, and said belly portion having a training pad adjacent said closures.

2. A method of training a dog, using a housetraining shirt that partially covers the body of a dog having a back portion with closures, a neck collar, foreleg sleeves, and a belly portion with closures and a training pad, comprising:
Inserting the forelegs of the dog through said foreleg sleeves; inserting the head of the dog through said neck collar; extending said back portion over the back of the dog, and extending said belly portion over the belly of the dog and through the hindlegs; clasping said closures to join said belly portion to said back portion and around the tail of the dog; removing the housetraining shirt when said dog provides the desired response.
